(19) United States
(12) Patent Application Publication
(10) Pub. No.: US 2007/0269119 A1
(43) Pub. Date: Nov. 22, 2007

(54) Method and apparatus for composing a composite still image

(75) Inventors: Robert H. Hyerle, Grenoble (FR); Adam Franks, Grenoble (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/491,190

(22) Filed: Jul. 24, 2006

(30) Foreign Application Priority Data
May 22, 2006 (EP) 06300499.8

(51) Int. Cl. G06K 9/46

(52) U.S. Cl. 382/236

(57) ABSTRACT

A method of composing a composite still image from multiple still image instances of a time varying scene comprises encoding the still image instances using an encoding scheme arranged to encode differences between a difference image instance and a reference image instance as difference information. The method further comprises composing the composite still image from one of the difference image and instance and the reference image instance together with the difference information.

This application claims priority from European patent application 06300499.8, filed on May 22, 2006. The entire content of the aforementioned application is incorporated herein by reference.

### FIELD OF THE INVENTION

The invention relates to a method and apparatus for composing a composite still image.

### BACKGROUND OF THE INVENTION

In still photography, the capturing of an image at an instant, problems can arise in ensuring that the captured image is the desired one. For example, referring to FIG. 1 which is a schematic view of still image instances of a human face shown at different instance it will be seen that in image 100 taken at a first instant the subject 102 has his left eye closed whereas in the image 104 taken at a second instant the subject 102 has his right eye closed. As a result, even where the photographer has taken several photographs to increase the chance that a good image is captured, it still may not be possible to produce the desired image. Hence complex image editing to construct a desired image by selecting pieces from a set of images and stitching them together may be required. However this is troublesome and time consuming and can require considerable skill.

Another problematic aspect of still image capture such as photography is capturing and depicting motion. For example FIG. 2 is a scene showing a moving object comprising a ball 200 passing a tree 202 at two instants 204, 206. Depicting motion can be done by panning the camera to move with the ball 200, taking advantage of the non-zero exposure time, smearing the background while the moving object remains clear. This can be seen in FIG. 3 which is a still image captured in this manner across an exposure time defined by the interval spanning instants 204, 206. As can be seen the image of the tree is blurred. Furthermore this approach depicts motion from the point of view of the moving object rather than from the point of view of the observer and no displacement of the moving object (or parts of the object) is depicted.

The invention is set out in the claims. Because the method relies on multiple still image instances encoded or compressed by an encoding or compression scheme such as mpeg which encodes differences between different image instances as difference information for example associated with a motion vector, the composite still image can be composed from one of the still image instances together with the difference information for example by applying or undoing a motion vector so as, effectively, to form a composite image from different parts of different image instances. Because the system relies on an encoding scheme which automatically captures difference information a simple approach is immediately available. Furthermore identification of specific changes to be made to an image does not require, for example, careful delineation of areas or stitching together of selective areas as this can be performed automatically dependent on the encoded difference information.

### BRIEF DESCRIPTION OF THE DRAWINGS

Embodiments of the invention will now be described, by way of example only, with reference to the drawings, of which:

FIG. 1 is a schematic view showing two still image instances according to a first aspect;

FIG. 2 shows a schematic view of a scene at two instants;

FIG. 3 is a schematic view showing an image of the view of FIG. 2 for an exposure time across the two instants;

FIG. 4 is a schematic view showing composition of a composite still image according to an embodiment;

FIG. 5 is a schematic view showing a composite still image composed according to the approach shown in FIG. 4;

FIG. 6 is a flow diagram illustrating steps involved in composing the composite image according to an embodiment;

FIG. 7 is a schematic view showing composition of a composite still image according to a further embodiment;

FIG. 8 is a schematic view of a composite still image formed according to the approach shown in FIG. 7; and

FIG. 9 is a block diagram illustrating the components of an apparatus for performing the message described herein.

### DETAILED DESCRIPTION OF THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In overview a composite still image such as a digital photograph is composed from multiple time varying still image instances, for example a sequence of individual still images captured sequentially in time. The multiple still images are encoded using an encoding scheme such as mpeg. As discussed in more detail below, a compression step in mpeg encoding comprises encoding one or more still image instances by identifying and storing only the differences between those instances and a reference image in the form of difference information associated with a delta or motion vector. In addition mpeg encoding in some instances allows identification of individual aspects of an image as objects. The composite still image can then be composed from one of the still image instances for example the reference image instance or a difference image instance together with the difference information. For example if it is identified that an aspect of the scene changed between instances undesirably then that change (together with all other changes) will be represented as difference information such that the difference information can simply be undone. As a result the composite image will correspond to say, the difference image in all aspects except for the non-desired change which can simply be undone.

As a result interval photography, where a sequence of instances are captured over a time interval, with the particular instant determined by various means such as regular or periodic capture as in a movie or triggered captures as used in stop-motion or time lapse photography can be used to produce one or more composite still images that is a synthesis of the interval. In particular areas that it is desired to change can be simply identified and dealt with simply by undoing the difference information or, indeed, applying difference information as appropriate. Furthermore these differences can be identified simply by identifying all difference information corresponding to a selected area or mpeg object where mpeg supports such objects.

The mpeg standards are well known to the skilled reader and described at www.chiariglione.org/mpeg such that detailed description is not required. However for the purposes of clarity certain basic principles will now be set out.

According to the mpeg standard mpeg 2 a sequence of images or frames are encoded for example of a time-varying scene. The sequence of images is encoded into a sequence of encoded frames. The first frame the sequence will typically be an intra-frame or I-Frame which contains all of the information necessary to reconstruct a complete image, acting as a reference image instance. Subsequent frames in the sequence will typically be predictive (P) or bi-directional (B) frames which contain only difference information between one or more other frames.

Much of the compression available from the mpeg standard arises because aspects of a scene do not necessarily change significantly or at all between multiple image instances captured at intervals during a time-varying scene. As a result subsequent (or indeed preceding) frames or image instances termed here difference image instances to the reference frame can simply replicate those aspects of the image common with the reference frame such that only differences between the frames need be recorded. In particular according to the mpeg standard the reference frame is segmented into blocks of pixels and each block is encoded and compressed in an appropriate manner such as Discrete Co-sign Transform (DCT). Difference image instances such as P- or B-frames are similarly encoded using DCT into blocks and the blocks are compared with a reference image instance or another difference image instance. If the blocks are identical then the compared frame does not need to record the detailed pixel information but can simply replicate the corresponding block from the reference frame. If the blocks differ slightly then only the differences need be recorded as difference information in the difference image instance for example as a “delta”. If an object has moved between image instances then movement of the corresponding blocks from the reference frame can be encoded as a “motion vector” for example in terms of the instance and direction moved by the block. Of course if a block in a P-frame or B-frame cannot be identified, say, in the I-frame then all of the pixel information must be encoded in the B- or P-frame. As a result the mpeg scheme comprises an encoding scheme which not only performs the initial DCT encoding but also encodes differences between a difference image instance and a reference frame or image instance which may itself be a difference image instance as difference information associated with a motion vector or delta.

According to versions of mpeg such as mpeg 4, in addition specific elements at a scene can be identified and encoded as mpeg objects or “video objects” such that video scenes can be composed of multiple, independent varying objects.

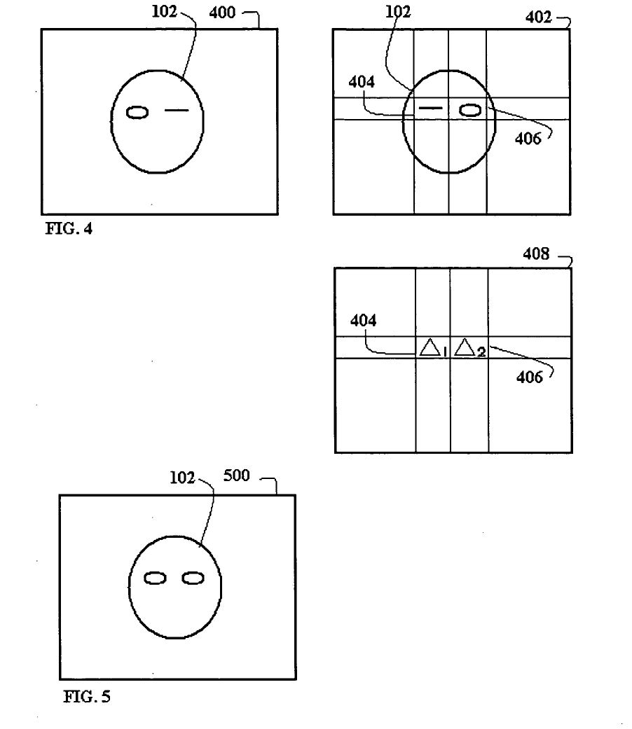

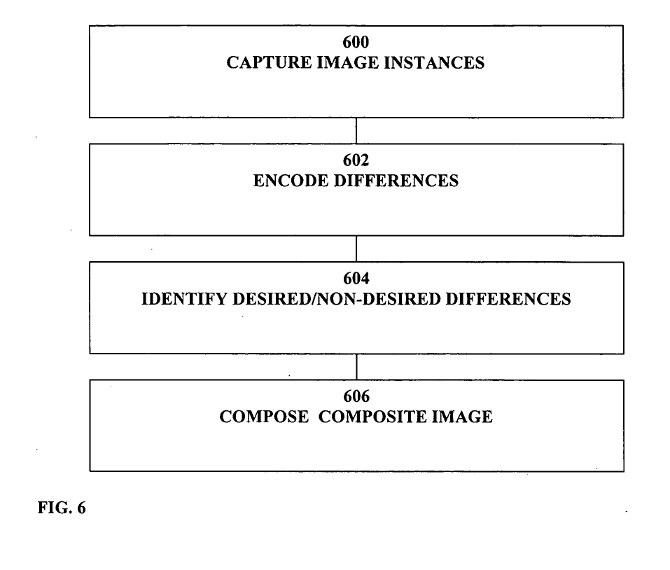

The method described herein, according to one embodiment, can be further understood with reference to FIGS. 4 and 5 which show image instances and a composite still image formed therefrom, and FIG. 6 which is a flow diagram setting out the steps involved in implementing the method.

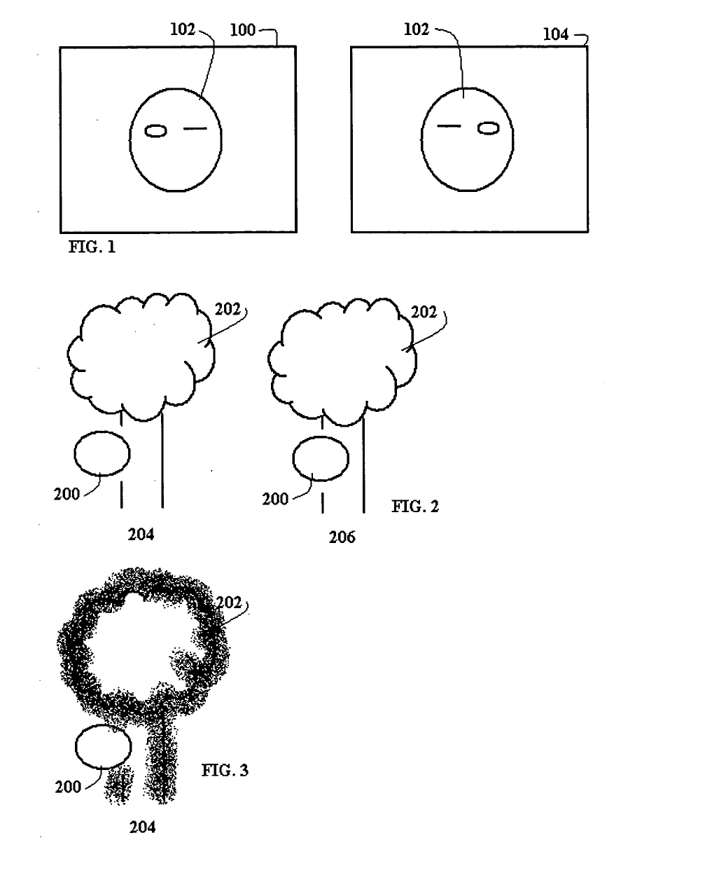

At step 600 in FIG. 6, multiple time varying still image instances are captured. The sequence of images is captured over an interval of time and may be, for example, captured in response to a human activating image capture, may be periodic as for movies or may be triggered by other events such as motion in the scene, changes of light in the scene and so forth. Referring to FIG. 4, which repeats the example of FIG. 1, first and second image instances 400, 402 are captured of a human face where the left eye and then the right eye is closed.

At step 602, the differences between the images are obtained as part of standard mpeg encoding. The images can be immediately or subsequently stored in the mpeg form. Where, for example, image instance 400 is the reference image instance or I-frame and image instance 402 is the difference image instance or B-frame or P-frame the differences are encoded as deltas or motion vectors as shown at 404. In particular it can be seen that difference image instance 402 is divided into blocks (only two of which, each of which may represent multiple blocks in practice, are shown fully for ease of understanding) 404, 406. It will be seen that at 402 the difference information is recorded as Δ1, and Δ2. In addition, objects (for example each eye) may be identified and encoded.

Reverting to FIG. 6, at step 604 the differences of interest are identified. These may either be differences that the selector wishes to undo as undesirable or differences which the selector wants to implement as desirable. For example referring to the difference image instance 402 at FIG. 4 the selector may decide that the closed right eye is not desired, and that, instead, an image of the subject with both eyes open is desired. As a result it is simply necessary to undo the corresponding difference information Δ1 in block 404. Hence at step 606 the composite image is composed as shown at 500 in FIG. 5, where the subject appears to have both eyes open, and is effectively composed from all of the reference image together with only the difference information Δ2 which is the open by from the difference image instance. It will be seen, of course, that, instead of undoing one of the deltas in the difference image, a delta can be applied to the reference image in the form of delta 2, and these approaches are effectively interchangeable.

It will further be noted that identification by the selector or the desired change is achieved very simply. For example where the difference image instance is represented on a GUI such as a camera or computer screen, the selector can identify the area where it is desired to undo a change in any appropriate manner for example by defining the relevant area with a mouse or on a touch screen. If the selector then also identifies the reference image containing the desired replacement area then all difference information in the selected area on the difference image instance can be automatically identified for example by virtue of the coordinates of the corresponding encoded block or blocks, and the difference information simply undone.

Alternatively or in addition, the user may identify the, where supported by the mpeg version, video object requiring changes the system then undoing/applying the corresponding difference information.

Indeed the difference information can be used to identify to the selector or editor what has changed and the editor can then select the version of the object that is desired, where the undesired difference is not apparent. The composite image or selected version can then be constructed by using or omitting deltas from the sequence to construct the final still image which hence does not represent a specific point in time but a synthesis of an interval of time. Individual aspects may not have time coherence as events that occurred out of order can be represented on a single composite image. It will further be recognised that multiple changes can be selected between multiple images and the deltas applied such that a final image may be a composite of multiple individual image instances.

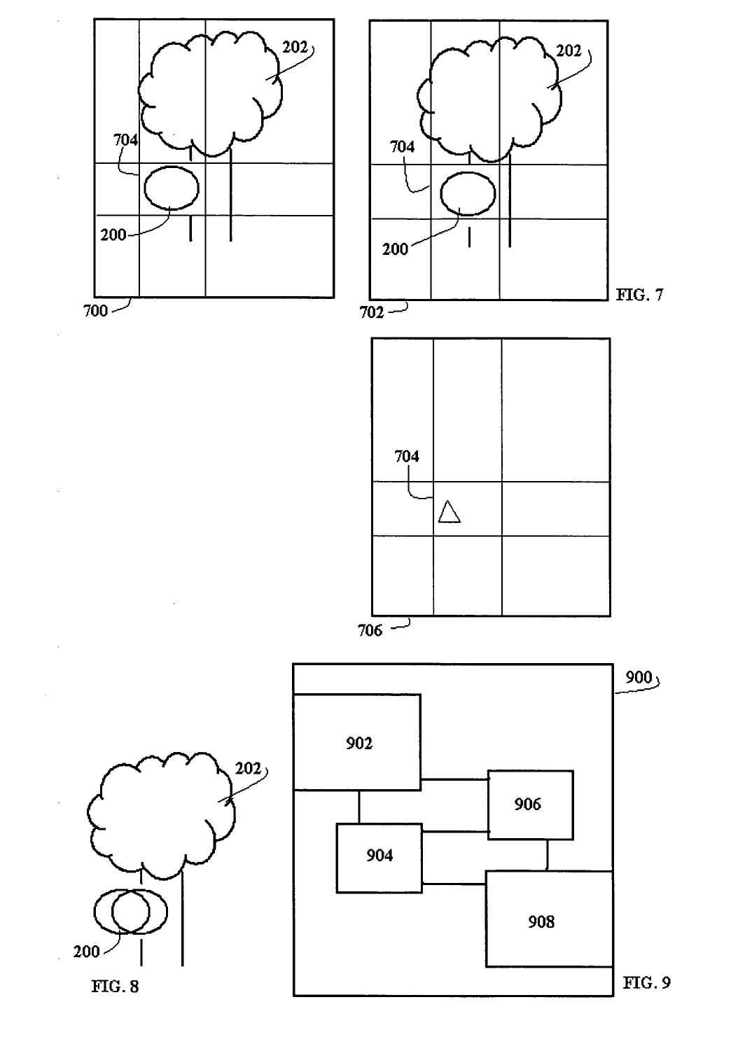

According to another embodiment of the method, motion or other effects can be depicted by applying repeated deltas, as can be seen from FIGS. 7 and 8 which show the approach described herein applied to the scenario described above with reference to FIG. 2. The two time sequential scenes in FIG. 7 are captured as a reference image instance 700 and a difference image instance 702. Block 704 in the difference image instance 702, corresponding to the moving ball 200 (in practice this is likely to be multiple blocks) is identified as corresponding to block 704 in reference image instance 700 and is represented as difference information A at 706. Then motion can be depicted as shown in FIG. 8 by applying repeated deltas or motion vectors to show the moving ball 200 at multiple times as it moves across a fixed background 202. Of course multiple difference image instances can be adopted to provide additional depictions of motion and objects rather than deltas can be identified and replicated. According to another embodiment other aspects of an image can be manipulated, and an “average” image may be computed over multiple deltas. One such example is intensity. In that case, the delta between images may represent only a variation in pixel intensity such that darkening or lightening effects can be undone/applied, or an average intensity across multiple instances applied for example by obtaining an average delta, per block, across multiple instances. In a further instance the average position of an aspect can be computed from multiple deltas across multiple image instances, allowing, for example, stitching together of a composite image of an object of which differing portions are visible in respective image instances.

It will be appreciated that the method described herein can be implemented on any appropriate apparatus for example a digital camera or computer apparatus configured to encode multiple image instances according to the mpeg or similar standard. Such an apparatus is shown schematically as 900 in FIG. 9. The apparatus includes an image capture or download port 902 which can be for example a CCD or a USB port to another device from which the image is received, a memory module 904 for storing image data and a processor 906 for processing the image data for example to encode it according to the mpeg format. The device 900 further comprises an image display or upload module 908 for example a GUI or display screen or a USB port to an external device.

Accordingly when multiple image instances are captured they can be processed according to the mpeg standard and the difference information encoded. The user can then, for example, view the desired images on a GUI, select the desired images and changes and store, display or print the images as appropriate.

It will be appreciated that the method steps can be implemented in any appropriate manner for example in software or hardware and that appropriate code for manipulation of the images and composition of a composite still image in the manner described above can be programmed in any suitable manner as will be apparent to the skilled reader without the requirement for detailed discussion here.

As a result of the arrangement described herein a simple image composition system is provided in which the editor is not required to identify objects which have boundaries, for example but can simply rely on identification of changes and in which the editor is not limited to selection from a set of instance; fictional instance can be constructed as desired.

It will be appreciated that the approaches described herein can be implemented using any version of the mpeg standard (mpeg-1, mpeg-2, mpeg-4, mpeg-7 or mpeg-21) or indeed any other encoding scheme in which differences between image instances are encoded as difference information for example the H.26* standard promulgated by the International Telecommunication Union (ITU) and described at www.itu.int. Any appropriate criteria for the creation of the synthesis can be adopted for example desired/selected objects, average intensities, depiction of motion such that video recording technology e.g. mpeg can be used advantageously to identify and select objects, intensities, motion and so forth to compose the still images.

1. A method of composing a composite still image from multiple still image instances of a time varying scene, in which the still image instances are encoded using an encoding scheme arranged to encode differences between a difference image instance and a reference image instance as difference information, comprising composing the composite still image from one of the difference image instance and the reference image instance together with the difference information.

2. A method as claimed in claim 1 further comprising identifying an image instance aspect it is desired to change and one of undoing or applying difference information corresponding to the aspect.

3. A method as claimed in claim 2 in which the image instance aspect comprises a video object.

4. A method as claimed in claim 1 in which the encoding scheme comprises one of mpeg or H.26*.

5. A method as claimed in claim 4 in which the encoding scheme is mpeg, the reference image instance comprises an I-frame, B-frame or P-frame and the difference image instance comprises a B-frame or P-frame.

6. A method as claimed in claim 4 in which the difference information comprises a motion vector or delta.

7. A method as claimed in claim 1 in which the composite still image is composed by selecting one of the difference image instance or reference image instance and one of applying or undoing the difference information.

8. A method as claimed in claim 1 comprising composing the composite still image from two or more still image instances.

9. A method as claimed in claim 1 further comprising applying multiple versions of corresponding difference information in a composite image.

10. A method as claimed in claim 1 further comprising obtaining an average of multiple difference information instances.

11. A method as claimed in claim 10 in which the difference information corresponds to intensity difference or position.

12. An apparatus for composing a composite still image from multiple still image instances of a time varying scene captured using an encoding scheme arranged to encode differences between a difference image instance and a reference image instance as difference information comprising a processor arranged to compose the composite still image from one of the difference image instance and a reference image instance together with the difference information.

13. A computer readable medium containing instructions arranged to operate a processor to implement the method of claim 1.
